(19) United States
(12) Patent Application Publication
(10) Pub. No.: US 2010/0023313 A1
(43) Pub. Date: Jan. 28, 2010

(54) Image Generation for Use in Multilingual Operation Programs

(76) Inventors: Fridolin Faist, Oberwolfach (DE); Andreas Isenmann, Haslach i.K. (DE)

Correspondence Address: FAY KAPLUN & MARCIN, LLP, 150 BROADWAY, SUITE 702, NEW YORK, NY, 10038, US

(21) Appl. No.: 12/507,499

(22) Filed: Jul. 22, 2009

Related U.S. Application Data
(60) Provisional application No. 61/084,096, filed on Jul. 28, 2008.

(30) Foreign Application Priority Data
Jul. 28, 2008 (EP) 08 161 272.3

(51) Int. Cl. G06T 11/00; G10L 11/00

(52) U.S. Cl. 704/2; 704/E11.001; 345/467

(57) ABSTRACT

An image with text in a selected language for use in a multilingual operating program for a fill-level measuring device or a pressure measuring device is generated in that a text-free image is overlaid with the corresponding text modules in the selected language. This does not require changing the image. The overlay is controlled by means of a control file.

### REFERENCE TO RELATED APPLICATION

This application claims the benefit of the filing date of EP Patent Application Serial No. 08 161 272.3 filed on 28 Jul. 2008 and U.S. Provisional Patent Application Ser. No. 61/084,096 filed on 28 Jul. 2008, the disclosure of which applications is hereby incorporated herein by reference.

### FIELD OF THE INVENTION

The invention relates to image generation for fill level measuring or pressure measuring. In particular, the invention relates to a method for generating an image with text in a selected language for use in a multilingual operating program for fill level measuring or pressure measuring, to a program element, to a computer-readable medium and to a control device for a fill-level measuring device or a pressure measuring device.

### TECHNOLOGICAL BACKGROUND

Already at present, images to clarify certain facts are used in operating programs (operating tools) with multilingual user interfaces. Many of these images not only consist of purely graphic elements, but in addition they also comprise language-dependent elements, e.g. text. Such images may need to be provided separately for each and every target language. As an alternative, the text can also be created so as to be language-independent. One option of this is, for example, the simple consecutive numbering of the elements of the graphic, which elements are to be described. Since this is merely a reference to some other position, the operator may need to collect the sought information via several steps, which may clearly limit user-friendliness.

As a rule, translations are carried out by translators who have experience in the commonly used programs such as, for example, Microsoft Word™ or Microsoft Excel™, These programs are optimised for pure text input. Likewise, databases can be used to administer text blocks and their translations. Examples of such databases include Access™ Microsoft SQL Server, MySQL and Oracle.

If the texts contained in the images are to be translated, then graphics software may have to be used for this purpose. If the images are present in a pure graphics format, then the texts contained in the graphic may have to be replaced by the respective translation. If in this process the contained texts of the graphics element overlap with the graphic information, then any replacement of the text information involves considerable effort and expenditure. Examples of pure graphics formats include JPG, BMP, GIF, TIFF, etc.

Special graphics programs, such as Adobe Photo Shop™ make it possible to work in several planes (or layers). In this arrangement, for example, one plane (or layer) can be used to receive the purely graphic information. The texts can be overlaid in other planes of the graphic, and are thus more easily accessible for translation. If the images generated in this process are to be used in operating tools, then as a rule the images must first be converted to a pure graphics format, for example JPG, BMP, GIF or TIFF. If such graphics programs are used for translation, then the selection of translators available for translation is clearly limited, because the required special knowledge is often not available.

At times numerous language-dependent images for each target language may have to be administered. All the changes, irrespective as to whether they relate to a text or a graphic element, may result in enormous expenditure in the maintenance of the existing images. As a rule, normal procedures such as the “search and replace” command can often not be used.

### SUMMARY OF THE INVENTION

Stated are a method for generating an image with text in a selected language for use in a multilingual operating program for fill level measuring or pressure measuring, a program element, a computer-readable medium, and a control device for a fill-level measuring device or a pressure measuring device according to the characteristics of the independent claims. Further embodiments of the invention are stated in the subordinate claims.

The described exemplary embodiments relate equally to the method, the program element, the computer-readable medium and the control device.

According to an exemplary embodiment of the invention, a method for generating an image with text in a selected language for use in a multilingual operating program for fill level measuring or pressure measuring is stated, in which method image data that corresponds to a visualisable image is provided. Furthermore, control data for controlling an overlay of the image data with text data that relates to the image data and that corresponds to a text in the selected language is provided. This is followed by an overlay of the image data and the text data with the use of the control data.

In other words, the control data comprises information as to which text data is to be overlaid at which location of the image with the image data. It should be noted that image data refers for example to processed data of an image ready for being depicted on a computer screen. Or, at a later point in time from the image data a visualisable image, i.e. an image that can be shown on a display, can be generated.

Furthermore, the already generated image can be overlaid with the text data or the already generated text modules in the corresponding language.

This may provide improved generation of auxiliary images for multilingual operating programs, in particular for fill level measuring or for pressure measuring.

In this way auxiliary images for multilingual operating tools can be made available in a simple manner in all target languages without this requiring any changes in the actual image information. Computing power, administrative effort and translation effort can thus be reduced. Only the text file (text data) needs to be translated. This may not require any further knowledge, for example in relation to the operation of a graphics program.

By separating the text information from the graphic information, the images need not be conveyed to each target language. Both the graphics and the overlaid text can be conveniently administered and edited. The required space on the data carrier (both for storing the image and the text) is reduced. Furthermore, the centrally administered images and the associated texts can be used for designing the user interfaces for all the operating tools supported. This may considerably reduce the effort of preparing the graphics, because the language-dependent images do not have to be prepared separately for each operating tool.

The term “image data” and/or “image” may refer to pixel data or graphic data and not to, e.g., HTML data.

According to a further exemplary embodiment of the invention, the term “image data” refers to a visualisable image, while the term “text data” refers to a visualisable text.

In other words, it is not the raw data (from which the images and texts are prepared) that are overlaid, but instead it is the finished image with the corresponding finished text modules.

According to a further exemplary embodiment of the invention, the image data is free of any text. Processing the image data at the time of changing the target language is thus not required.

According to a further exemplary embodiment of the invention, the image data is no longer changed by the overlay with the text data. Thus only one version of the image data needs to be stored that is used unchanged to be overlaid with all the text modules (in the respective target language).

According to a further exemplary embodiment of the invention, the control data is provided as a control file. This control file can be stored in a storage device of the control device. The storage device is, for example, a control device that is installed so as to be stationary and that comprises a monitor and a corresponding arithmetic-logic unit or a mobile control device, for example a mobile output- and control unit that can be placed on, or connected to, the fill-level measuring device or the pressure measuring device.

Data transmission between the control device and the fill-level measuring device or the pressure measuring device can take place either in a wired manner, for example by way of a data bus, or in a wireless manner.

According to a further exemplary embodiment of the invention, the control data comprises information as to the location in the image at which a particular text module is to be overlaid with the image.

According to a further exemplary embodiment of the invention, the control data comprises formatting information of the text.

Thus, the text may be translated independently of the desired formatting. Text formatting is then, during the overlaying of image and text, carried out by the control program that accesses the control data. The control data can be centrally administered and updated, for example by way of a central server.

According to a further exemplary embodiment of the invention, user-controlled selection of the language of the text to be overlaid takes place. In other words, the user, for example by way of a corresponding input unit, may select the target language s/he desires.

Furthermore, according to a further exemplary embodiment of the invention, selecting the language of the text to be overlaid may take place automatically, for example in that the control device determines the country it is in. To this effect, for example, a GPS receiver present in the control device can be used. In other words, the generated (auxiliary) image for the operating program is displayed to the user in each case in the suitable language, without the user having to become involved. Of course, users can also select the desired language themselves.

According to a further exemplary embodiment of the invention, the text data is stored in a database in a storage device. The control data is designed to make possible the referencing and identification of the text data.

In this way, by way of the control data, at any point in time the corresponding text data may be found, which text data is subsequently to be overlaid with the image.

According to a further exemplary embodiment of the invention, the text data is administered by means of a database.

According to a further exemplary embodiment of the invention, overlaying the image data and the text data takes place during operation of the operating program, in other words during the runtime of the operating tool.

In this way time may be saved. As a rule, the user may not be affected by this because the process takes place fully automatically in the background.

According to a further exemplary embodiment of the invention, a program element is stated which, when it is executed on a processor, instructs the processor to carry out the process steps stated above.

According to a further exemplary embodiment of the invention, a computer-readable medium is stated which, when it is executed on a processor, instructs the processor to carry out the process steps stated above.

According to a further exemplary embodiment of the invention, a control device for a fill-level measuring device or for a pressure measuring device is stated, wherein the control device comprises an arithmetic-logic (calculation unit) unit for generating an image with text in a selected language for use in a multilingual operating program for the fill-level measuring device or for the pressure measuring device, wherein the arithmetic-logic unit is designed to carry out the process steps stated above.

Below, exemplary embodiments of the invention are described with reference to the figures.

### BRIEF DESCRIPTION OF THE FIGURES

FIG. 1 shows a flow chart of a method according to an exemplary embodiment of the invention.

FIG. 2 shows a control device according to an exemplary embodiment of the invention.

FIG. 3 shows a fill-level measuring device with a control device according to an exemplary embodiment of the invention.

FIG. 4 shows a language-dependent graphic for a DTM according to an exemplary embodiment of the invention.

FIG. 5 shows a language-dependent graphic in an EDD according to an exemplary embodiment of the invention.

### DETAILED DESCRIPTION OF EXEMPLARY EMBODIMENTS

The illustrations in the figures are diagrammatic and not to scale.

In the following description of the figures the same reference characters are used for identical or similar elements.

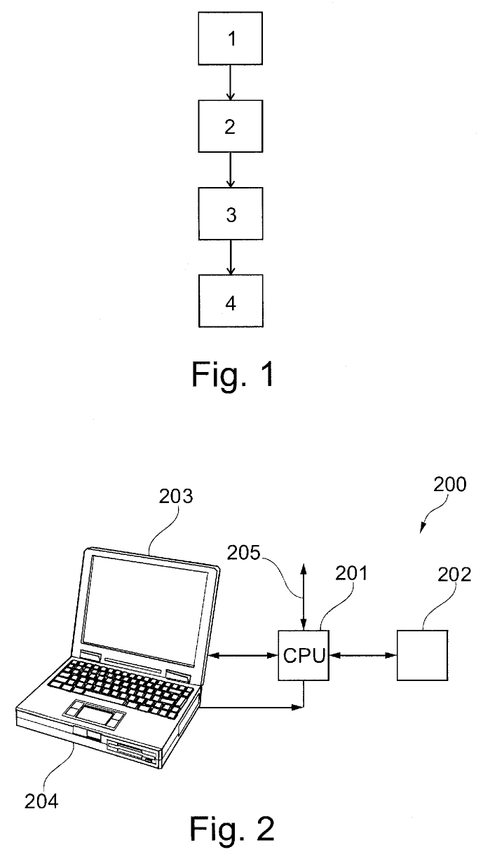

FIG. 1 shows a flow chart of a method according to an exemplary embodiment of the invention. In a first step, image data that corresponds to an image to be visualised is provided. For each and every image (or for each and every image data set) that comprises language-dependent elements, apart from the actual text-free image a control file (or control data) is made available. This takes place in step 2. This control data is used to overlay the image data with the text data.

The control file can, for example, be present in XML format, with said control file comprising information as to which point in the graphic is to be overlaid with what texts. Furthermore, the control file can also comprise formatting information such as the alignment of the text modules or the fonts or font sizes to be used. The texts or text modules and their translations that are referenced and identified by this control file can be administered in the usual way, for example with the use of databases.

In step 3 the control file accesses the database in which the text data is stored, and selects the matching text modules in a suitable language.

In step 4, finally, the image data and the text data are overlaid with the use of the control data. In other words, the overlay is carried out by an arithmetic-logic unit that is instructed by the control file as to how to carry out the overlay.

According to the invention, the language-dependent images are generated in that texts from a database are referenced by way of the control file and at the corresponding position are overlaid on a text-free, and thus language-independent, graphic.

Depending on the options which the operating tool to be used provides, this text overlay can take place during runtime of the operating tools. This means that the language-dependent graphic is generated only at the point in time of use. This approach is, for example, possible in the case of a DTM.

Other operating tools may not offer any possibility of generating graphics during runtime; instead they can present only existing graphics. Examples of this are all the operating tools that operate on the basis of electronic device description (EDD) technology, such as Emerson AMS, Siemens PDM, etc.

For such operating tools, too, the present invention may be used. The multitude of language-dependent images can be generated by an image generator from the language-independent images at the front end. However, to this effect a rule needs to be defined as to the way the file name of the language-dependent graphic is to be structured for this graphic to then be referenced from the EDD.

The language-dependent images may, for example, be conveyed, with the use of a control file, from the language-independent base graphic “Adjustment.jpg” to the language-dependent graphics “Adjustment_de.jpg”,“Adjustment_en.jpg” and “Adjustment_fr.jpg”. The example shows that the file name of the language-dependent graphics has been expanded by a two-digit country abbreviation. These language-dependent graphics can be referenced in the EDD in which the path information relating to the graphics is stated in a language-dependent way. In this example the path information would be as follows:

“|de|Adjustment_de.jpg|en|Adjustment_en.jpg|fr|Adjustment_fr.jpg”

FIG. 2 shows a diagrammatic view of a control device according to an exemplary embodiment of the invention. The control device 200 comprises an arithmetic-logic unit 201 (CPU). The arithmetic-logic unit 201 is connected to an input unit 204 and an output unit 203 that is designed in the form of a display. By way of the input unit 204 the user can, for example, carry out parameterisation of the fill-level measuring device or of the pressure measuring device, as well as select the desired language.

Furthermore, a storage unit 202 is provided, which is connected to the arithmetic-logic unit 201. By way of a communication connection 205, for example in the form of a data bus or a radio connection, the arithmetic-logic unit is connected to the measuring device. In the storage device 202 or on the CPU 201 a computer program (program element) is stored which can implement the method described. Moreover, the program element can be loaded by way of the internet.

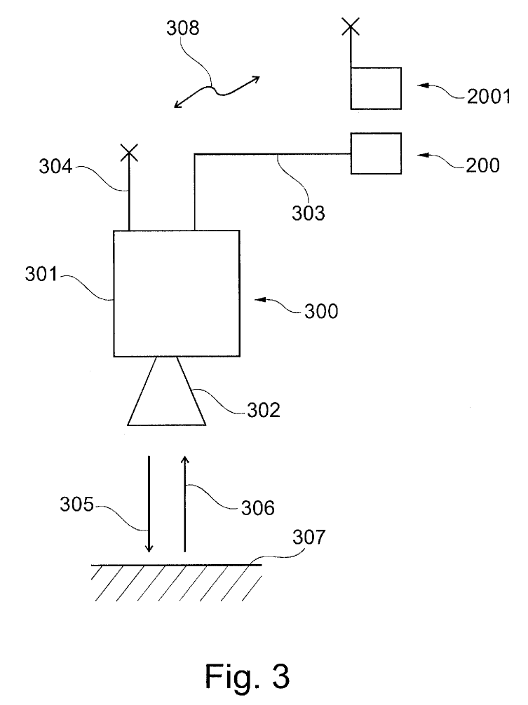

FIG. 3 shows a diagrammatic view of a fill-level measuring device 300 that is connected to a control device 200 by way of a data bus 303, and to a second control device 2001 by way of a wireless data transmission path 308.

The fill-level measuring device 300 comprises in particular an electronics module 301 and an antenna 302. A corresponding antenna is also provided for the second control device 2001. The antenna emits transmission data 305 in the direction of a product surface 307. The data 306 reflected at that location is received by the antenna 302 and is evaluated in the electronics 301. The corresponding measuring result can then be transmitted to the control devices 200, 2001 either in a cable-bound manner or in a wireless manner.

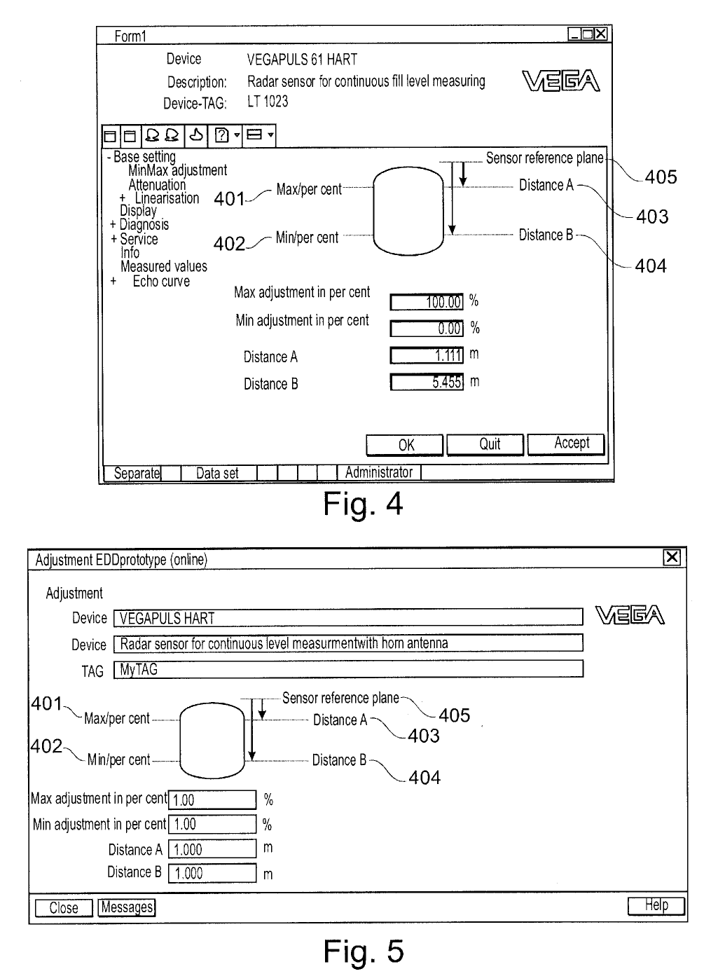

FIG. 4 shows the use of a language-dependent graphic in a DTM. In this process the language-dependent texts “Max/per cent” 401, “Min/per cent” 402, “Distance A” 403, “Distance B” 404 and “Sensor reference plane” 405 are overlaid with the use of the control data of the language-independent adjustment graphic.

The abbreviation DTM refers to a device type manager. DTMs make use of field device tool (FDT) technology. FDT technology describes a standardised communication interface between field devices and systems. FDT technology uses binary files (DTM) as a user-interface description file in order to describe the user interface of the associated field device. The user-interface description file is written in a user-interface description language and is read into the operating tool (e.g. PACTware) that is used, in order to address the field device by way of the operating tool.

FIG. 5 shows the use of the language-dependent file from FIG. 4 in an EDD. The abbreviation EDD refers to Electronic Device Description. This is another concept for utilising a standardised communication interface between field devices and systems. In this context the device description (DD) concept, the electronic device description (EDD) concept, and the enhanced EDD (EEDD) concept should be mentioned. In the case of DD, EDD or EEDD the user interface or the device description is provided in an ASCII text that has been written in a description language that is comparable to the programming language C. For this reason the user-interface description file is a text file. In EDD technology, text files (DD, EDD or enhanced EDD) are used as a user-interface description file in order to describe the user interface of the associated field device. The user-interface description file is written in a user-interface description language and is read into the operating tool (e.g. PDM by Siemens) used, in order to be able to address the operating tool by way of the field device.

In addition, it should be pointed out that “comprising” does not exclude other elements or steps, and “a” or “one” does not exclude a plural number. Furthermore, it should be pointed out that characteristics or steps which have been described with reference to one of the above exemplary embodiments can also be used in combination with other characteristics or steps of other exemplary embodiments described above. Reference characters in the claims are not to be interpreted as limitations.

What is claimed is:

1. A method for generating an image with text in a selected language for use in a multilingual operating program for one of a fill level measuring and a pressure measuring, comprising:
providing image data which corresponds to a visualisable image;
providing control data for controlling an overlay of the image data with text data that relates to the image data and that corresponds to a text in the selected language; and
overlaying the image data and the text data with the use of the control data.

2. The method according to claim 1, wherein the image data is a visualisable image, and the text data is a visualisable text.

3. The method according to claim 1, wherein the image data is free of any text.

4. The method according to claim 1, wherein the image data is not changed by the overlay.

5. The method according to claim 1, wherein the control data is provided as a control file.

6. The method according to claim 1, wherein the control data comprises information as to the location in the image at which a particular text module is to be overlaid with the image.

7. The method according to claim 1, wherein the control data comprises formatting information of the text.

8. The method according to claim 1, further comprising:
overlaying user-controlled selection of the language of the text.

9. The method according to claim 1, further comprising:
storing the text data in a database; and
referencing and identifying the text data using the control data.

10. The method according to claim 1, further comprising:
administering the text data using a database.

11. The method according to claim 1, wherein overlaying the image data and the text data takes place during operation of the operating program.

12. A program element which, when it is executed on a processor, instructs the processor to carry out the following steps:
providing image data which corresponds to a visualisable image;
providing control data for controlling an overlay of the image data with text data that relates to the image data and that corresponds to a text in the selected language; and
overlaying the image data and the text data with the use of the control data.

13. A computer-readable medium on which a program element is stored which, when it is executed on a processor, instructs the processor to carry out the following steps:
providing image data that corresponds to a visualisable image;
providing control data for controlling an overlay of the image data with text data that relates to the image data and that corresponds to a text in the selected language;
overlaying the image data and the text data with the use of the control data.

14. A control device for one of a fill-level measuring device and a pressure measuring device, comprising:
a calculation unit generating an image with text in a selected language for use in a multilingual operating program for one of the fill-level measuring device and the pressure measuring device, wherein the calculation unit is designed to carry out the following steps:
providing image data that corresponds to a visualisable image;
providing control data for controlling an overlay of the image data with text data that relates to the image data and that corresponds to a text in the selected language; and
overlaying the image data and the text data with the use of the control data.

15. A control device according to claim 14, wherein the image data is a visualisable image and the text data is a visualisable text.
